(19) United States
(12) Patent Application Publication
(10) Pub. No.: US 2016/0186049 A1
(43) Pub. Date: Jun. 30, 2016

(54) COATED PROPPANTS CONTAINING HYPERBRANCHED POLYURETHANE COATINGS AND METHODS FOR USING SAME

(71) Applicant: Georgia-Pacific Chemicals LLC, Atlanta, GA (US)

(72) Inventors: Jason M. Bothwell, Atlanta, GA (US); Richard A. Rediger, Conyers, GA (US)

(73) Assignee: Georgia-Pacific Chemicals LLC, Atlanta, GA (US)

(21) Appl. No.: 14/970,462

(22) Filed: Dec. 15, 2015

Related U.S. Application Data
(60) Provisional application No. 62/097,677, filed on Dec. 30, 2014.

(51) Int. Cl. C09K 8/80

(52) U.S. Cl. CPC C09K 8/805

(57) ABSTRACT

Coated proppants that include hyperbranched polyurethane coatings and methods for making and using same. The coated proppant can include a particle and a polyurethane coating at least partially encasing the particle. The polyurethane coating can include a reaction product of a hyperbranched polyol and a polyisocyanate. The hyperbranched polyol can include a reaction product of a chain extender and a polyol monomer. The coated proppant can have a dry crush strength of about 0.1 wt % to about 5 wt % at a pressure of about 96.5 MPa, based on the Proppant Crush Resistance Test Procedure under ISO 13503-2:2011.

### CROSS-REFERENCE TO RELATED APPLICATION

This application claims priority to U.S. Provisional Patent Application No. 62/097,677, filed on Dec. 30, 2014, which is incorporated by reference herein.

### BACKGROUND

1. Field

Embodiments described generally relate to proppants and methods for making and using same. More particularly, such embodiments relate to coated proppants that include hyperbranched polyurethane coatings and methods for making and using same.

2. Description of the Related Art

The production of oil, natural gas, and other petroleum fluids from a subterranean formation can be enhanced by utilizing the technique of hydraulic fracturing. In general, hydraulic fracturing involves the injection of a fracturing fluid through a well bore and against the face of the subterranean formation to initiate new fractures and/or extend existing fractures in the subterranean formation. The fracturing fluid must be injected at a pressure and a flow rate great enough to overcome the overburden pressure, as well as to drive the fracturing of the subterranean formation.

The fracturing fluid usually contains a proppant, such as sand or gravel, which is carried into the fractures. The proppant particles become lodged in the fractures where the particles minimize or eliminate fracture reduction or closure upon reduced downhole pressures due to the removal of petroleum and or fracturing fluids. The proppant filled fractures provide permeable channels through which the petroleum fluids flow to the well bore and thereafter are withdrawn for production. The high closure stresses applied to the proppant particles lodged in a fracture can fragment and disintegrate the proppant if the proppant has a dry crush strength too low in value for the particular environment of the fracture. For example, a closure pressure of about 34.5 MPa and greater can disintegrate frac sand traditionally used as a proppant. The resulting fines from the disintegrated proppant can migrate and plug the interstitial flow passages in the remaining proppant filled fractures.

These migratory fines drastically reduce the permeability of the propped fractures, which reduces or ceases petroleum production from such clogged fractures.

There is a need, therefore, for an improved proppant that has a dry crush strength greater than traditional proppants and methods for making and using same.

### SUMMARY

Coated proppants and methods for making and using same are provided. In one or more embodiments, a coated proppant can include a particle and a polyurethane coating at least partially encasing the particle. The polyurethane coating can include a reaction product of a hyperbranched polyol and a polyisocyanate. The hyperbranched polyol can include a reaction product of a chain extender and a polyol monomer. The coated proppant can have a dry crush strength of about 0.1 wt % to about 5 wt % at a pressure of about 96.5 MPa, based on the Proppant Crush Resistance Test Procedure under ISO 13503-2:2011.

In other embodiments, the coated proppant can include a particle and a polyurethane coating at least partially encasing the particle. The polyurethane coating can include a reaction product of a hyperbranched polyol and a polyisocyanate. The hyperbranched polyol can consist essentially of carbon, hydrogen, and oxygen. The hyperbranched polyol can have a degree of branching of about 35% to about 80%. The coated proppant can have a mesh size of about 80 to about 10, based on the U.S. Standard Sieve Series and a dry crush strength of about 0.1 wt % to about 3 wt % at a pressure of about 55.2 MPa, based on the Proppant Crush Resistance Test Procedure under ISO 13503-2:2011.

In one or more embodiments, a method for treating a subterranean formation can include introducing a fluid comprising a plurality of coated proppants into a wellbore, and introducing the plurality of coated proppants into the subterranean formation via the wellbore. Each coated proppant can include a particle and a polyurethane coating at least partially encasing the particle. The polyurethane coating can include a reaction product of a hyperbranched polyol and a polyisocyanate. The hyperbranched polyol can include a reaction product of a chain extender and a polyol monomer.

### DETAILED DESCRIPTION

One or more polyol monomers (e.g., a triol such as trimethylolpropane) and one or more chain extenders (e.g., a dialkylolpropionic acid such as dimethylolpropionic acid) can be reacted with one another to produce a hyperbranched polyol. The hyperbranched polyol can be combined with a plurality of particles and one or more polyisocyanates and the hyperbranched polyol and the polyisocyante can react with one another to produce a plurality of coated proppants that can include a hyperbranched polyurethane coating at least partially encasing each of the particles. It has been surprisingly and unexpectedly discovered that the coated proppants can have a dry crush strength of about 0.1 wt % to about 5 wt % or about 0.5 wt % to less than 5 wt % at a pressure of about 96.5 MPa, based on the Proppant Crush Resistance Test Procedure under ISO 13503-2:2011. It has also been surprisingly and unexpectedly discovered that the coated proppants can have a dry crush strength of about 0.1 wt % to about 3 wt % or about 0.5 wt % to less than 3 wt % at a pressure of about 55.2 MPa, based on the Proppant Crush Resistance Test Procedure under ISO 13503-2:2011.

The polyol monomers can be compounds having two or more hydroxyl groups. The polyol monomers can be or include, but are not limited to, one or more diols, triols, tetraols, pentaols, or other compounds containing six or more hydroxyl groups, or any mixture thereof. Illustrative polyol monomers can be or include, but are not limited to, one or more of trimethylolpropane (“TMP”—also known as 2-ethyl-2-(hydroxymethyl)-1,3-propanediol), trimethylolbutane, pentaerythritol, dipentaerythritol, ethylene glycol, propylene glycol, glycerol, sorbitol, salts thereof, isomers thereof, derivatives thereof, or any mixture thereof.

The chain extenders can be compounds having two or more hydroxyl groups and one or more carboxyl groups. Illustrative chain extenders can be or include, but are not limited to, one or more dialkylolethanoic acids, dialkylolpropionic acids, dialkylolbutanoic acids, dialkylolpentanoic acids, trialkylolpropionic acids, trialkylolbutanoic acids, trialkylolpentanoic acids, salts thereof, isomers thereof, derivatives thereof, or any mixture thereof. Illustrative dialkylolpropionic acids can be or include, but are not limited to, one or more of dimethylolpropionic acid (“DMPA”—also known as 2,2-bis(hydroxymethyl)propionic acid), diethylolpropionic acid, dipropylolpropionic acid, salts thereof, isomers thereof, derivatives thereof, or any mixture thereof. In one specific example, the polyol monomer can be TMP and the chain extender can be DMPA such that the hyperbranched polyol can include a reaction product of DMPA and TMP.

The polyisocyanates are cross-linkers and can be compounds having two or more isocyanate groups. Illustrative polyisocyanates can be or include, but are not limited to, hexamethylene diisocyanate (HDI), isophorone diisocyanate (IPDI), cyclohexane diisocyanate (CHDI), toluene diisocyanate (TDI), methylenediphenylene diisocyanate (MDI), salts thereof, isomers thereof, derivatives thereof, or any mixture thereof. Other cross-linkers can be used in combination with or as a substitute for the polyisocyanate, such as melamine-formaldehyde resins, isocyanurates, polyepoxides, or any mixture thereof. The cross-linkers can be or include, but are not limited to, fully or partially methylated hexamethoxymethylmelamine (commercially available as CYMEL® 303 resin from Palmer Holland, Inc.), butoxymethylmelamines, butoxy, methoxymethylmelamines, isocyanurates derived from a polyisocyanate (e.g., HDI, IPDI, CHDI, TDI, or MDI), epoxide resins (e.g., the commercially available epoxide resins such as the EPON® epoxide resins from Hexion Inc.), bis-phenol A type epoxides, acrylic polymers with glycidylacrylate or methacrylate as one of the monomers, salts thereof, isomers thereof, derivatives thereof, or any mixture thereof.

The hyperbranched polyol can be produced from a reaction mixture that includes the chain extender and the polyol monomer in an amount of about 1, about 2, about 3, about 4, about 5, about 6, about 8, about 10, about 12, about 15, about 18, about 20, about 25, or about 30, about 40, or about 50 molar equivalents of the chain extender to one molar equivalent of the polyol monomer. In one or more examples, the hyperbranched polyol can be produced from a reaction mixture by combining the chain extender and the polyol monomer in an amount of about 2 molar equivalents to about 30 molar equivalents, about 2 molar equivalents to about 25 molar equivalents, about 2 molar equivalents to about 20 molar equivalents, about 2 molar equivalents to about 15 molar equivalents, or about 2 molar equivalents to about 10 molar equivalents of the chain extender to one molar equivalent of the polyol monomer. For example, the hyperbranched polyol can be produced from a reaction mixture containing DMPA and TMP in an amount of about 2 molar equivalents to about 30 molar equivalents of DMPA to one molar equivalent of TMP.

In one example, all of the chain extender and all of the polyol monomer can be combined with one another to form the reaction mixture that is subsequently mixed and heated to produce the hyperbranched polyol. In another example, a first portion of the chain extender and all of the polyol monomer can be initially added to form the reaction mixture that can be mixed and heated to produce an intermediate product (e.g., an initial hyperbranched polyol with a lower weight average molecular weight than the final hyperbranched polyol). Thereafter, a second portion of the chain extender can be added to the intermediate product to form a mixture that can be mixed and heated to produce the final hyperbranched polyol.

In some examples, a first generation hyperbranched polyol can be produced from a reaction mixture formed by combining the chain extender and the polyol monomer in an amount of about 2 molar equivalents to about 5 molar equivalents of the chain extender to one molar equivalent of the polyol monomer. For example, the first generation hyperbranched polyol can be produced from a reaction mixture containing DMPA and TMP in an amount of about 2 molar equivalents to about 4 molar equivalents of DMPA to one molar equivalent of TMP.

In other examples, a second generation hyperbranched polyol can be produced from a reaction mixture formed by combining the chain extender and the polyol monomer in an amount of about 6 molar equivalents to about 12 molar equivalents of the chain extender to one molar equivalent of the polyol monomer. For example, the second generation hyperbranched polyol can be produced from a reaction mixture containing DMPA and TMP in an amount of about 8 molar equivalents to about 10 molar equivalents of DMPA to one molar equivalent of TMP.

In other examples, a third generation hyperbranched polyol can be produced from a reaction mixture formed by combining the chain extender and the polyol monomer in an amount of about 15 molar equivalents to about 25 molar equivalents of the chain extender to one molar equivalent of the polyol monomer. All of the chain extender and all of the polyol monomer can be combined together before mixing and reacting to produce the hyperbranched polyol. Alternatively, portions of the chain extender can be added to a reaction mixture containing the polyol monomer at two or more different times during the reaction to produce the third generation hyperbranched polyol. In one example, the third generation hyperbranched polyol can be produced from a reaction mixture containing DMPA and TMP in an amount of about 19 molar equivalents to about 23 molar equivalents of DMPA to one molar equivalent of TMP.

In one or more examples, one or more catalysts can be combined with the chain extender and the polyol monomer to form the reaction mixture for producing the hyperbranched polyol. The catalyst can promote or accelerate an esterification reaction between the chain extender and the polyol monomer to produce the hyperbranched polyol. The catalyst can be or include sulfuric acid, dibutyltin oxide, another esterification catalyst, or any mixture thereof. In some examples, the reaction mixture for producing the hyperbranched polyol can include the catalyst in an amount of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.2 wt %, about 1.5 wt %, about 1.7 wt %, or about 2 wt %, based on a weight of the chain extender. For example, the reaction mixture for producing the hyperbranched polyol can include the chain extender, the polyol monomer, and the catalyst, where the reaction mixture can include about 0.1 wt % to about 2 wt %, about 0.1 wt % to about 1.5 wt %, about 0.1 wt % to about 1 wt %, about 0.1 wt % to about 0.7 wt %, about 0.2 wt % to about 2 wt %, about 0.2 wt % to about 1.5 wt %, about 0.2 wt % to about 1 wt %, about 0.2 wt % to about 0.7 wt %, about 0.3 wt % to about 2 wt %, about 0.3 wt % to about 1.5 wt %, about 0.3 wt % to about 1 wt %, about 0.3 wt % to about 0.7 wt %, about 0.4 wt % to about 2 wt %, about 0.4 wt % to about 1.5 wt %, about 0.4 wt % to about 1 wt %, about 0.4 wt % to about 0.7 wt %, or about 0.4 wt % to about 0.6 wt % of the catalyst, based on the weight of the chain extender. In some specific examples, the reaction mixture for producing the hyperbranched polyol can include the desired molar equivalents of the chain extender to one molar equivalent of the polyol monomer, and also include about 0.1 wt % to about 2 wt %, about 0.1 wt % to about 1 wt %, about 0.2 wt % to about 0.7 wt %, or about 0.4 wt % to about 0.6 wt % of the catalyst, based on the weight of the chain extender.

In some examples, the first generation hyperbranched polyol can be produced from a reaction mixture formed by combining the chain extender, the polyol monomer, and the catalyst in an amount of about 2 molar equivalents to about 5 molar equivalents of the chain extender to one molar equivalent of the polyol monomer, and about 0.1 wt % to about 2 wt % of the catalyst, based on the weight of the chain extender. For example, the first generation hyperbranched polyol can be produced from a reaction mixture containing about 2 molar equivalents to about 4 molar equivalents of DMPA to one molar equivalent of TMP, and about 0.3 wt % to about 0.7 wt % of sulfuric acid, based on a weight of the DMPA.

In other examples, the second generation hyperbranched polyol can be produced from a reaction mixture formed by combining the chain extender, the polyol monomer, and the catalyst in an amount of about 6 molar equivalents to about 12 molar equivalents of the chain extender to one molar equivalent of the polyol monomer, and about 0.1 wt % to about 2 wt % of the catalyst, based on the weight of the chain extender. For example, the second generation hyperbranched polyol can be produced from a reaction mixture containing about 8 molar equivalents to about 10 molar equivalents of DMPA to one molar equivalent of TMP, and about 0.3 wt % to about 0.7 wt % of sulfuric acid, based on a weight of the DMPA.

In other examples, the third generation hyperbranched polyol can be produced from a reaction mixture formed by combining the chain extender, the polyol monomer, and the catalyst in an amount of about 15 molar equivalents to about 25 molar equivalents of the chain extender to one molar equivalent of the polyol monomer, and about 0.1 wt % to about 2 wt % of the catalyst, based on the weight of the chain extender. For example, the third generation hyperbranched polyol can be produced from a reaction mixture containing about 19 molar equivalents to about 23 molar equivalents of DMPA to one molar equivalent of TMP, and about 0.3 wt % to about 0.7 wt % of sulfuric acid, based on a weight of the DMPA.

The reaction mixture can be heated to a temperature of about 50° C., about 80° C., about 100° C., or about 120° C. to about 150° C., about 180° C., or about 200° C. to produce the hyperbranched polyol. For example, the reaction mixture can be heated to a temperature of about 50° C. to about 200° C., about 100° C. to about 180° C., about 120° C. to about 180° C., or about 130° C. to about 150° C. to produce the hyperbranched polyol. The reaction mixture can be heated for about 0.1 hr, about 0.5 hr, about 0.8 hr, about 1 hr, or about 1.5 hr to about 2 hr, about 2.5 hr, about 3 hr, about 4 hr, or about 5 hr to produce the hyperbranched polyol. For example, the reaction mixture can be heated for about 0.1 hr to about 5 hr, about 0.5 hr to about 5 hr, about 1 hr to about 4 hr, about 1 hr to about 3 hr, or about 1 hr to about 2 hr to produce the hyperbranched polyol. The reaction mixture can be maintained under an inert atmosphere, such as an atmosphere containing one or more inert gases and/or under vacuum, when the reaction mixture is heated to produce the hyperbranched polyol. For example, a purge gas containing nitrogen (N₂), argon, or other inert gas sufficiently non-reactive to the reaction mixture can flow over and/or through the reaction mixture. In one specific example, the reaction mixture can be maintained under a nitrogen purge gas and heated to a temperature of about 120° C. to about 160° C. for about 1 hr to about 3 hr.

In one or more examples, a first generation hyperbranched polyol core can further be reacted with the same chain extender used to produce the first generation hyperbranched polyol core or a different chain extender, one or more additional times, as desired, to cause further branching and growth of the hyperbranched polyol. Such additional polymerization of the first generation hyperbranched polyol core, when used, can produce a second, third, fourth, or higher generation hyperbranched polyol core, as desired.

In another example, the method for forming the hyperbranched polyol can include reacting a hyperbranched polyol core, at any level of generational branching, with an intermediate substituent that can include a polyfunctional carboxylic anhydride or acid thereof, to form an intermediate polyester macromolecule having reactive carboxyl groups thereon. The intermediate substituent can be or include, but is not limited to, phthalic acid, isophthalic acid, orthophthalic anhydride, tetrahydrophthalic anhydride, hexahydrophthalic anhydride (HHPA), trimellitic anhydride, succinic anhydride, similar such compounds, or any mixture thereof. The intermediate substituent can include cyclic polyfunctional carboxylic anhydrides. In one example, the intermediate substituent can include hexahydrophthalic anhydride (HHPA), methyl, hexahydrophthalic anhydride, or a mixture thereof.

The hyperbranched polyol can have a degree of branching of about 10%, about 20%, about 25%, about 30%, about 35%, about 40%, about 45%, about 50%, about 55%, about 60%, about 65%, about 70%, about 75%, about 80%, about 90%, or greater. For example, the hyperbranched polyol can have a degree of branching of about 10% to about 90%, about 20% to about 90%, about 30% to about 90%, about 10% to about 80%, about 20% to about 80%, about 30% to about 80%, about 30% to about 70%, about 30% to about 60%, about 30% to about 50%, about 35% to about 80%, about 35% to about 70%, about 35% to about 60%, about 35% to about 50%, about 40% to about 70%, about 40% to about 60%, or about 40% to about 50%. In some examples, the hyperbranched polyol can have a degree of branching of about 30% or greater, such as about 35% to about 80%, or about 40% to about 60%. The degree of branching for the hyperbranched polyols is a ratio of the amount of the polyols containing branched polymers to the sum of the amounts of the polyols containing branched polymers and the polyols containing unbranched polymers, as determined by quantitative (inverse gated heteronuclear decoupled) nuclear magnetic resonance (NMR) spectroscopy.

In one or more examples, the coated proppant can include one or more particles and a polyurethane coating at least partially encasing the particle. The polyurethane coating can include the reaction product of one or more hyperbranched polyols and one or more polyisocyanates. The hyperbranched polyol can consist essentially of carbon, hydrogen, and oxygen. The hyperbranched polyol can have a degree of branching of about 30% or greater. In at least one example, the hyperbranched polyol can consist essentially of carbon, hydrogen, and oxygen and can have a degree of branching of about 10% to about 90%, about 20% to about 85%, about 35% to about 80%, about 40% to about 85%, or about 45% to about 90%.

The hyperbranched polyol can have a number average molecular weight (Mₙ) of about 100, about 200, about 300, about 400, about 500, about 600, about 700, about 800, or about 900 to about 1,000, about 1,500, about 2,000, about 2,500, about 3,000, about 3,500, about 4,000, about 4,500, about 5,000, about 6,000, about 7,000, about 8,000, about 9,000, about 10,000, or greater. For example, the number average molecular weight of the hyperbranched polyol can be about 100 to about 10,000, about 300 to about 8,000, about 500 to about 5,000, about 500 to about 4,000, about 500 to about 3,000, about 500 to about 2,000, about 500 to about 1,000, about 700 to about 5,000, about 700 to about 4,000, about 700 to about 3,000, about 700 to about 2,000, or about 700 to about 1,000. In some examples, the number average molecular weight of the hyperbranched polyol can be about 500 to about 3,000 or about 700 to about 2,000.

The hyperbranched polyol can have a weight average molecular weight (M_{w}) of about 300, about 400, about 500, about 600, about 700, about 800, or about 900 to about 1,000, about 1,500, about 2,000, about 2,500, about 3,000, about 3,500, about 4,000, about 4,500, about 5,000, about 6,000, about 7,000, about 8,000, about 9,000, about 10,000, or greater. For example, the weight average molecular weight of the hyperbranched polyol can be about 300 to about 10,000, about 500 to about 8,000, about 600 to about 7,000, about 600 to about 6,000, about 600 to about 5,000, about 600 to about 4,000, about 600 to about 3,000, about 800 to about 8,000, about 800 to about 7,000, about 800 to about 6,000, about 800 to about 5,000, about 800 to about 4,000, about 800 to about 3,000, about 800 to about 2,000, about 900 to about 8,000, about 900 to about 7,000, about 900 to about 6,000, about 900 to about 5,000, about 900 to about 4,000, about 900 to about 3,000, or about 900 to about 2,000. In some examples, the weight average molecular weight of the hyperbranched polyol can be about 800 to about 5,000 or about 900 to about 4,000.

In one or more examples, the number average molecular weight can be less than the weight average molecular weight. For example, the hyperbranched polyol can have a number average molecular weight of about 500 to about 3,000 and a weight average molecular weight of about 800 to about 5,000, where the number average molecular weight is less than the weight average molecular weight. In another example, the hyperbranched polyol can have a number average molecular weight of about 700 to about 2,000 and a weight average molecular weight of about 900 to about 4,000, where the number average molecular weight is less than the weight average molecular weight.

The number average molecular weight (Mₙ) is the statistical average molecular weight of all the polymer chains in the hyperbranched polyol. The weight average molecular weight (M_{w}) takes into account the molecular weight of a chain in determining contributions to the molecular weight average. The Mₙ and the M_{w} can be measured using gel permeation chromatography (“GPC”), also known as size exclusion chromatography (“SEC”). For example, the instrument used to measure the Mₙ and M_{w} can be acquired from Waters Corporation and can include a pump (model 515) and a differential refractive index detector (model 2414). The solvent used in the analysis can be tetrahydrofuran (THF) that can be pumped at a rate of about 1 mL/min. Separation can be achieved with a series of three 30 cm Mixed-C columns (available from Agilent Technologies) that can be heated to a temperature of about 27° C. The instrument can be calibrated using polystyrene standards obtained from Agilent Technologies. Samples can be diluted to about 10 mg/mL with THF. Toluene can be added to the dilute solution as a retention time standard and the solution can be injected into the instrument through a RHEODYNE® injector. Data can be processed and molecular weight averages can be calculated with the EMPOWER® software available from Waters.

The coated proppants can be utilized to hold open formation fractures formed during the hydraulic fracturing process. Each coated proppant can have one or more particles contained therein. The particles can be or include, but are not limited to, one or more of sand, gravel, nut or seed media, mineral fibers, natural fibers, synthetic fibers, ceramics, or any mixture thereof. Illustrative sand that can be utilized as particles can be or include, but is not limited to, one or more of frac sand, silica sand, glass, quartz, silicon dioxide, silica, silicates, other silicon oxide sources, or any mixture thereof. The type of sand used as the particles can have a variety of shapes and sizes. The sand may be relatively rounded or have spherical or substantially spherical grains or the sand may be an angular sand having sharp or less rounded grains. Similarly, particulates other than sand, such as ceramics, may be spherical or substantially spherical with rounded edges or angular with sharp or jagged edges. Other suitable shapes or forms the particulates can be include, but are not limited to, beads, pellets, flakes, cylinders, and the like.

Illustrative beads and pellets that can be utilized as particles can be or include, but are not limited to, one or more metals (e.g., aluminum, iron, steel, or alloys thereof), glass, sintered bauxite, ceramics (e.g., aluminum, zirconium, hafnium, and/or titanium oxide sources), mineral particulates, synthetic polymers or resins (e.g., nylon, polyethylene, or polypropylene), or any mixture thereof. In some examples, the particles can be or include rigid, substantially spherical pellets or spherical glass beads, such as UCAR® props, commercially available from Union Carbide Corporation. In some examples, the particles can be or include metallic beads and/or pellets that contain aluminum, iron, steel, alloys thereof. In some examples, the particles can be or include metallic beads and/or pellets that contain ceramics.

The particles can include, but are not limited to, one or more silicon oxide sources (e.g., silica, silicates, silicon dioxide, or other silicon oxides), aluminum oxide sources (e.g., alumina, aluminates, or other aluminum oxides), zirconium oxide sources (e.g., zirconia, zirconium dioxide, or other zirconium oxides), hafnium oxide sources (e.g., hafnia, hafnium dioxide, or other hafnium oxides), titanium oxide sources (e.g., titania, titanium dioxide, or other titanium oxides), carbonate sources, other ceramic materials, other metal oxides, or any mixture thereof.

Nut or seed media can be, include, or produced from, but are not limited to, whole, broken, chopped, crushed, milled, and/or ground nuts, nut shells, seeds, and/or seed hulls, including tree nuts and oil seeds. Illustrative nuts or seeds can include, but is not limited to, almond, walnut, pecan, chestnut, hickory, cashew, peanut, macadamia, sunflower, linseed, rapeseed, castor seed, poppy seed, hemp seed, tallow tree seed, safflower seed, mustard seed, other tree nuts, other oilseeds, or any mixture thereof and can be used in or to produce the nut or seed media.

In one or more examples, the uncoated proppant or particles can have a mesh size from a low value of about 270 (about 53 μm), about 230 (about 63 μm), about 200 (about 75 μm), about 120 (about 125 μm), or about 100 (about 150 μm) to a high value of about 80 (about 180 μm), about 60 (about 250 μm), about 40 (about 425 μm), about 30 (about 600 μm), about 20 (about 850 μm), or about 10 (about 2 mm), based on the U.S. Standard Sieve Series. For example, the uncoated proppant or particles can have a mesh size of about 270 (about 53 μm) to about 10 (about 2 mm), about 230 (about 63 μm) to about 10 (about 2 mm), about 200 (about 75 μm) to about 10 (about 2 mm), about 200 (about 75 μm) to about 20 (about 850 μm), about 100 (about 150 μm) to about 10 (about 2 mm), or about 100 (about 150 μm) to about 20 (about 850 μm), based on the U.S. Standard Sieve Series.

In other examples, the uncoated proppant or particles can have a mesh size from a low value of about 120 (about 125 μm), about 100 (about 150 μm), about 80 (about 180 μm), about 60 (about 250 μm), or about 40 (about 425 μm) to a high value of about 30 (about 600 μm), about 20 (about 850 μm), or about 10 (about 2 mm), based on the U.S. Standard Sieve Series. For example, the uncoated proppant or particles can have a mesh size of about 80 (about 180 μm) to about 40 (about 425 μm), about 80 (about 180 μm) to about 20 (about 850 μm), about 80 (about 180 μm) to about 10 (about 2 mm), about 60 (about 250 μm) to about 40 (about 425 μm), about 60 (about 250 μm) to about 20 (about 850 μm), about 60 (about 250 μm) to about 10 (about 2 mm), about 40 (about 425 μm) to about 30 (about 600 μm), about 40 (about 425 μm) to about 20 (about 850 μm), or about 40 (about 425 μm) to about 10 (about 2 mm), based on the U.S. Standard Sieve Series. In some examples, the uncoated proppant or particles can be silica sand or frac sand and can have a mesh size of about 100 (about 150 μm) to about 10 (about 2 mm), based on the U.S. Standard Sieve Series. In other examples, the uncoated proppant or particles can be beads or pellets and can have a mesh size of about 200 (about 75 μm) to about 10 (about 2 mm), based on the U.S. Standard Sieve Series.

In one or more examples, a method for producing the coated proppant having the polyurethane coating at least partially encasing the uncoated particles is provided. The polyurethane coating can be or include the reaction product of the one or more hyperbranched polyols and the one or more cross-linkers, such as one or more polyisocyanates. A plurality of particles, the hyperbranched polyol, and the cross-linker (e.g., polyisocyanate) can be combined in a blender or mixer and the hyperbranched polyol and the cross-linker can react with one another to produce the coated proppant. In one example, the particles can be heated to a temperature of about 50° C. to about 300° C. and combined with the hyperbranched polyol in the mixer and mixed for about 0.1 min to about 5 min. Thereafter, the cross-linker can be added to the mixture and mixed for about 1 min to about 10 min to produce the coated proppants. The coated proppants can be removed from the mixer and allowed to cool to ambient temperature (e.g., about 23° C.) to produce the coated proppant having the polyurethane coating at least partially encasing the particles.

In some examples, the particles can be heated to a temperature of about 50° C., about 80° C., about 100° C., or about 120° C. to about 150° C., about 180° C., about 200° C., about 250° C., or about 300° C. when contacted with the hyperbranched polyol and/or the cross-linker. For example, the particles can be heated to a temperature about 50° C. to about 300° C., about 50° C. to about 200° C., about 50° C. to about 150° C., about 50° C. to about 100° C., or about 100° C. to about 200° C. when contacted with the hyperbranched polyol and/or the cross-linker.

The particles and the hyperbranched polyol can be mixed for about 0.1 min, about 0.2 min, about 0.3 min, or about 0.4 min to about 0.6 min, about 0.7 min, about 0.8 min, about 0.9 min, or about 1 min to about 2 min, about 3 min, about 4 min, or about 5 min. For example, the particles and the hyperbranched polyol can be mixed for about 0.1 min to about 5 min, about 0.2 min to about 3 min, about 0.3 min to about 1 min, about 0.2 min to about 0.8 min, or about 0.4 min to about 0.6 min. The particles, the hyperbranched polyol, and the cross-linker can be mixed for about 1 min, about 1.5 min, or about 2 min to about 3 min, about 5 min, about 7 min, or about 10 min. For example, the particles, the hyperbranched polyol, and the cross-linker can be mixed for about 1 min to about 10 min, about 1 min to about 5 min, about 1 min to about 3 min, or about 1 min to about 2 min.

Additional details related to methods for producing coated proppants can include those discussed and described in U.S. Pat. Nos. 8,003,214 and 8,133,587.

The coated proppant can have the polyurethane coating at least partially encasing or completely encasing one or more particles. The polyurethane coating containing one or more polyisocyanates provides the coated proppant with a surprisingly and unexpectedly improved dry crush strength value in comparison to traditional proppants. All dry crush strengths disclosed herein were measured or determined based on the Proppant Crush Resistance Test Procedure under ISO 13503-2:2011.

In one or more examples, at a pressure of about 96.5 MPa, the coated proppant can have a dry crush strength of about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, or about 7 wt %. For example, at a pressure of about 96.5 MPa, the coated proppant can have a dry crush strength of about 0.1 wt % to about 5 wt %, about 0.1 wt % to about 4.5 wt %, about 0.1 wt % to about 4 wt %, about 0.1 wt % to about 3.5 wt %, about 0.1 wt % to about 3 wt %, about 0.1 wt % to about 2.5 wt %, about 0.1 wt % to about 2 wt %, about 0.5 wt % to about 7 wt %, about 0.5 wt % to about 5 wt %, about 0.5 wt % to about 4 wt %, or about 0.5 wt % to about 3 wt %. In other examples, the coated proppant can have a dry crush strength of about 0.1 wt % to less than 5 wt %, about 0.1 wt % to less than 4.5 wt %, about 0.1 wt % to less than 4 wt %, about 0.1 wt % to less than 3.5 wt %, about 0.1 wt % to less than 3 wt %, about 0.1 wt % to less than 2.5 wt %, about 0.1 wt % to less than 2 wt %, about 0.5 wt % to less than 7 wt %, about 0.5 wt % to less than 5 wt %, about 0.5 wt % to less than 4 wt %, or about 0.5 wt % to less than 3 wt % at a pressure of about 96.5 MPa.

In other examples, at a pressure of about 55.2 MPa, the coated proppant can have a dry crush strength of about 0.1 wt %, about 0.3 wt %, about 0.5 wt %, about 0.7 wt %, about 1 wt %, about 1.2 wt %, about 1.5 wt %, about 1.7 wt %, about 2 wt %, about 2.2 wt %, about 2.5 wt %, about 2.7 wt %, about 3 wt %, about 3.2 wt %, about 3.5 wt %, about 3.7 wt %, about 4 wt %, about 4.2 wt %, about 4.5 wt %, about 4.7 wt %, about 5 wt %, about 5.2 wt %, about 5.5 wt %, about 5.7 wt %, about 6 wt %, about 6.5 wt %, or about 7 wt %. For example, at a pressure of about 55.2 MPa, the coated proppant can have a dry crush strength of about 0.1 wt % to about 5 wt %, about 0.1 wt % to about 4.5 wt %, about 0.1 wt % to about 4 wt %, about 0.1 wt % to about 3.5 wt %, about 0.1 wt % to about 3 wt %, about 0.1 wt % to about 2.5 wt %, about 0.1 wt % to about 2 wt %, about 0.1 wt % to about 1.5 wt %, about 0.1 wt % to about 1 wt %, about 0.1 wt % to about 0.5 wt %. In other examples, the at a pressure of about 55.2 MPa, the coated proppant can have a dry crush strength of about 0.5 wt % to less than 5 wt %, about 0.5 wt % to less than 4.5 wt %, about 0.5 wt % to less than 4 wt %, about 0.5 wt % to less than 3.5 wt %, about 0.5 wt % to less than 3 wt %, about 0.5 wt % to less than 2.5 wt %, about 0.5 wt % to less than 2 wt %, about 0.5 wt % to less than 1.5 wt %, or about 0.5 wt % to less than 1 wt %.

The coating on the coated proppant can have a thickness of about 2.5 μm, about 5 μm, about 7.5 μm, about 12.7 μm, about 17.8 μm, or about 22.9 μm, to about 25.4 μm, about 50.8 μm, about 76.2 μm, about 102 μm, about 127 μm, about 152 μm, about 178 μm, about 203 μm, about 229 μm, about 254 μm, about 381 μm, about 508 μm, or greater. For example, the coating on the coated proppant can have a thickness of about 2.54 μm to about 508 μm, about 2.54 μm to about 254 μm, or about 2.54 μm to about 127 μm. In some examples, the coated proppant can have a polyurethane coating with a thickness of about 2.5 μm to about 254 μm or about 2.5 μm to about 127 μm.

In some examples, the amount or weight of the coating on the coated proppant can be based on a total or combined weight of the coating and the particle. The amount or weight of the coating on the coated proppant can be about 0.2 wt %, about 0.5 wt %, about 0.7 wt %, about 0.9 wt %, or about 1 wt % to about 5 wt %, about 6 wt %, about 7 wt %, about 8 wt %, about 9 wt %, about 10 wt %, or about 12 wt %, based on the total weight of the coating and the particle. For example, the coating on the coated proppant can be about 0.2 wt % to about 12 wt %, about 0.5 wt % to about 10 wt %, about 0.5 wt % to about 5 wt %, about 1 wt % to about 12 wt %, about 1 wt % to about 10 wt %, or about 1 wt % to about 5 wt % of the coated proppant, based on the total weight of the coating and the particle. In some examples, the coated proppant can have a polyurethane coating that can be about 0.5 wt % to about 10 wt % or about 1 wt % to about 12 wt % of the coated proppant, based on the total weight of the coating and the particle.

In other examples, the amount or weight of the coating on the coated proppant can be based on just a weight of the particle. The amount or weight of the coating on the coated proppant can be about 0.5 wt %, about 0.7 wt %, about 0.9 wt %, or about 1 wt % to about 5 wt %, about 6 wt %, about 7 wt %, about 8 wt %, about 9 wt %, about 10 wt %, about 12 wt %, or about 15 wt %, based on the weight of the particle. For example, the coating on the coated proppant can be about 0.5 wt % to about 15 wt %, about 0.5 wt % to about 10 wt %, about 0.5 wt % to about 5 wt %, about 1 wt % to about 15 wt %, about 1 wt % to about 10 wt %, or about 1 wt % to about 5 wt % of the coated proppant, based on the total weight of the coating and the particle. In some examples, the coated proppant can have a polyurethane coating that can be about 0.5 wt % to about 10 wt % or about 1 wt % to about 15 wt % of the coated proppant, based on the weight of the particle.

In one or more examples, the coated particles can have a mesh size from a low value of about 230 (about 63 μm), about 200 (about 75 μm), about 120 (about 125 μm), or about 100 (about 150 μm) to a high value of about 80 (about 180 μm), about 60 (about 250 μm), about 40 (about 425 μm), about 30 (about 600 μm), about 20 (about 850 μm), about 10 (about 2 mm), about 8 (about 2.38 mm), about 6 (about 3.36 mm), or about 4 (about 4.76 mm), based on the U.S. Standard Sieve Series. For example, the coated particles can have a mesh size of about 200 (about 75 μm) to about 4 (about 4.76 mm), about 200 (about 75 μm) to about 6 (about 3.36 mm), about 200 (about 75 μm) to about 20 (about 850 μm), about 200 (about 75 μm) to about 80 (about 180 μm), about 100 (about 150 μm) to about 4 (about 4.76 mm), about 100 (about 150 μm) to about 6 (about 3.36 mm), about 100 (about 150 μm) to about 20 (about 850 μm), or about 100 (about 150 μm) to about 80 (about 180 μm), based on the U.S. Standard Sieve Series.

In other examples, the coated particles can have a mesh size from a low value of about 100 (about 150 μm), about 80 (about 180 μm), or about 60 (about 250 μm) to a high value of about 40 (about 425 μm), about 30 (about 600 μm), about 20 (about 850 μm), about 10 (about 2 mm), about 8 (about 2.38 mm), about 6 (about 3.36 mm), or about 4 (about 4.76 mm), based on the U.S. Standard Sieve Series. For example, the coated particles can have a mesh size of about 100 (about 150 μm) to about 4 (about 4.76 mm), about 100 (about 150 μm) to about 6 (about 3.36 mm), about 100 (about 150 μm) to about 20 (about 850 μm), about 80 (about 180 μm) to about 4 (about 4.76 mm), about 80 (about 180 μm) to about 6 (about 3.36 mm), about 80 (about 180 μm) to about 20 (about 850 μm), about 60 (about 250 μm) to about 4 (about 4.76 mm), about 60 (about 250 μm) to about 8 (about 2.38 mm), or about 60 (about 250 μm) to about 20 (about 850 μm), based on the U.S. Standard Sieve Series. In other examples, the coated particles can have a mesh size of about 40 (about 425 μm) to about 4 (about 4.76 mm), about 40 (about 425 μm) to about 20 (about 850 μm), about 20 (about 850 μm) to about 4 (about 4.76 mm), or about 10 (about 2 mm) to about 4 (about 4.76 mm), based on the U.S. Standard Sieve Series.

The coated proppants discussed and described herein can be utilized in processes and applications, such as, but not limited to, hydraulic fracturing, gravel packing, and well formation treatments. In one or more examples, a method for treating a subterranean formation can include introducing a fluid that contains a plurality of coated proppants into a wellbore, and introducing the plurality of coated proppants into the subterranean formation via the wellbore. Each coated proppant can include the polyurethane coating at least partially or completely encasing a particle, where the polyurethane coating can include the reaction product of the hyperbranched polyol and the polyisocyanate, and where the hyperbranched polyol can include the reaction product of the chain extender and the polyol monomer.

In some examples, the method can include servicing the subterranean formation with the plurality of coated proppants. The subterranean formation can be serviced with the coated proppants by introducing the coated proppants into desirable portions or areas of the wellbores and/or the subterranean formations, such as in fractures, cracks, holes, openings, and other orifices within the wellbores and/or the subterranean formations including the sidewalls or surfaces thereof. The proppants can be used in processes or treatments typically performed in wellbores and/or subterranean formations, including, but not limited to, hydraulic fracturing, gravel packing, and well formation treatments.

An agglomerated framework of coated proppants in the subterranean formation can reduce solid particle flow-back and/or the transport of formation fines from the subterranean formation. Additional details related to methods for using the coated proppants having the polyurethane coating can include those discussed and described in U.S. Pat. Nos. 8,003,214 and 8,133,587.

### EXAMPLES

In order to provide a better understanding of the foregoing discussion, the following non-limiting examples are offered. Although the examples may be directed to specific examples, they are not to be viewed as limiting the invention in any specific respect. All parts, proportions, and percentages are by weight unless otherwise indicated.

For Examples 1-5, the reagents or polyol monomers used to produce the polyols were trimethylolpropane (TMP) and dimethylolpropionic acid (DMPA). The number average molecular weight (Mₙ), the weight average molecular weight (M_{w}), and the degree of branching of the hyperbranched polyols are provided in Table 1 below.

Gel Permeation Chromatography (GPC) was used to obtain the data for determining the molecular weight distributions. The instrument used was supplied by the Waters Corporation and included a pump (model 515) and a differential refractive index detector (model 2414). The solvent used in the analysis was tetrahydrofuran (THF) that was pumped at a rate of about 1 mL/min. Separation was achieved with a series of three 30 cm Mixed-C columns (available from Agilent Technologies) that were heated to a temperature of about 27° C. The instrument was calibrated using polystyrene standards obtained from Agilent Technologies. Samples were diluted to about 10 mg/mL with THF. Toluene was added to the dilute solution as a retention time standard and the solution was injected into the instrument through a RHEODYNE® injector. Data was processed and molecular weight averages were calculated with the EMPOWER® software available from Waters. Quantitative (inverse gated heteronuclear decoupled) nuclear magnetic resonance (NMR) spectroscopy was used to obtain the degree of branching.

### Example 1

A reactor equipped with a thermometer, stirrer, Dean Stark trap and condenser, and a rubber stopper was charged with about 66.7 g of TMP, about 200 g of DMPA (about 3 molar equivalents based on TMP), and about 1 g of sulfuric acid (about 0.5 wt % based on the weight of DMPA). The mixture in the reactor was purged with nitrogen gas (N₂) and heated to about 140° C. under a nitrogen flow for about 2 hr. The reactor was placed under vacuum at a pressure of about 12 millibar for about 1 hr to remove excess water. The polyol was isolated from the reaction mixture. While hot, the polyol was poured out onto an aluminum pan to cool to room temperature (about 23° C.). Once cooled, the polyol was transferred to a flask. A sample of the hyperbranched polyol was analyzed via GPC and NMR. The M_{w} was about 3,379 g/mol, the Mₙ was about 1,558 g/mol, and the degree of branching was about 48%.

### Example 2

A reactor equipped with a thermometer, stirrer, Dean Stark trap and condenser, and a rubber stopper was charged with about 200 g of TMP, about 600 g of DMPA (about 3 molar equivalents based on TMP), and about 3 g of sulfuric acid (about 0.5 wt % based on the weight of DMPA). The mixture in the reactor was purged with nitrogen gas and heated to about 140° C. under a nitrogen flow for about 2 hr. The reactor was placed under vacuum at a pressure of about 12 millibar for about 1 hr to remove excess water. The polyol was isolated from the reaction mixture. While hot, the polyol was poured out onto an aluminum pan to cool to room temperature (about 23° C.). Once cooled, the polyol was transferred to a flask. A sample of the hyperbranched polyol was analyzed via GPC and NMR. The M_{w} was about 963 g/mol, the Mₙ was about 761 g/mol, and the degree of branching was about 44%.

### Example 3

A reactor equipped with a thermometer, stirrer, Dean Stark trap and condenser, and a rubber stopper was charged with about 20 g of TMP, about 180 g of DMPA (about 9 molar equivalents based on TMP), and about 0.9 g of sulfuric acid (about 0.5 wt % based on the weight of DMPA). The mixture in the reactor was purged with nitrogen gas and heated to about 140° C. under a nitrogen flow for about 2 hr. The reactor was placed under vacuum at a pressure of about 12 millibar for about 1 hr to remove excess water. The polyol was isolated from the reaction mixture. While hot, the polyol was poured out onto an aluminum pan to cool to room temperature (about 23° C.). Once cooled, the polyol was transferred to a flask. A sample of the hyperbranched polyol was analyzed via GPC and NMR. The M_{w} was about 1,090 g/mol, the Mₙ was about 763 g/mol, and the degree of branching was about 51%.

### Example 4

A reactor equipped with a thermometer, stirrer, Dean Stark trap and condenser, and a rubber stopper was charged with about 100 g of TMP, about 900 g of DMPA (about 9 molar equivalents based on TMP), and about 4.5 g of sulfuric acid (about 0.5 wt % based on the weight of DMPA). The mixture in the reactor was purged with nitrogen gas and heated to about 140° C. under a nitrogen flow for about 2 hr. The reactor was placed under vacuum at a pressure of about 12 millibar for about 1 hr to remove excess water. The polyol was isolated from the reaction mixture. While hot, the polyol was poured out onto an aluminum pan to cool to room temperature (about 23° C.). Once cooled, the polyol was transferred to a flask. A sample of the hyperbranched polyol was analyzed via GPC and NMR. The M_{w} was about 1,505 g/mol, the Mₙ was about 1,034 g/mol, and the degree of branching was about 47%.

### Example 5

A reactor equipped with a thermometer, stirrer, Dean Stark trap and condenser, and a rubber stopper was charged with about 55.6 g of TMP, about 500 g of DMPA (about 9 molar equivalents based on TMP), and about 2.5 g of sulfuric acid (about 0.5 wt % based on the weight of DMPA). The mixture in the reactor was purged with nitrogen gas and heated to about 140° C. under a nitrogen flow for about 2 hr. Once the condensation reaction was complete, the reactor was further charged with about 666.7 g of DMPA (about 12 molar equivalents based on TMP to provide a total of about 21 molar equivalents) and about 3.3 g of sulfuric acid (about 0.5 wt % based on DMPA). The mixture in the reactor was purged with nitrogen gas and heated to about 140° C. under a nitrogen flow for about 2 hr. The reactor was placed under vacuum at a pressure of about 12 millibar for about 1 hr to remove excess water. The polyol was isolated from the reaction mixture. While hot, the polyol was poured out onto an aluminum pan to cool to room temperature (about 23° C.). Once cooled, the polyol was transferred to a flask. A sample of the hyperbranched polyol was analyzed via GPC and NMR. The M_{w} was about 3,505 g/mol, the Mₙ was about 1,923 g/mol, and the degree of branching was about 44%.

TABLE 1
Hyperbranched Polyol Synthesis Results

| | Generation | DMPA:TMP | M_{w} | Mₙ | Degree of |
|---|---|---|---|---|---|
| Ex | of Polyol | (molar equiv) | (g/mol) | (g/mol) | Branching (%) |
| 1 | 1 | 3:1 | 3,379 | 1,558 | 48 |
| 2 | 1 | 3:1 | 963 | 761 | 44 |
| 3 | 2 | 9:1 | 1,090 | 763 | 51 |
| 4 | 2 | 9:1 | 1,505 | 1,034 | 47 |
| 5 | 3 | 21:1 | 3,505 | 1,923 | 44 |

For Examples 6-10, proppants were produced by coating sand particles with the hyperbranched polyols prepared in Experiments 2, 4, and 5, as listed in Table 2. The sand used was 20/40 frac sand, commercially available from Unimin Corporation. The poly(methylene diphenyl diisocyanate) (PMDI) used was MONDUR® 541-Light, commercially available from Bayer MaterialScience, L.L.C., Pittsburgh, Pa. All dry crush strength values measured in Examples 6-10 were determined based on the Proppant Crush Resistance Test Procedure under ISO 13503-2:2011.

### Example 6

About 2,000 g of sand was preheated to a temperature of about 260° C. and about 54 g of the Example 4 polyol was added to a 19 liter mixer. The mixer was run for about 30 sec, then about 26 g of PMDI was added to the mixture and mixed for about 2.5 min to produce coated proppants. Thereafter, the coated proppants were discharged from the mixer and allowed to cool in the ambient to about 23° C. The dry crush value was determined to be about 1.1 wt % at about 55.2 MPa.

### Example 7

About 2,000 g of sand was preheated to a temperature of about 260° C. and about 54 g of the Example 4 polyol were added to a 19 liter mixer. The mixer was run for about 30 sec, then about 26 g of PMDI was added to the mixture and mixed for about 2.5 min to produce coated proppants. Thereafter, the coated proppants were discharged from the mixer and allowed to cool in the ambient to about 23° C. The dry crush value was determined to be about 0.6 wt % at about 55.2 MPa.

### Example 8

About 2,000 g of sand was preheated to a temperature of about 260° C. and about 54 g of the Example 5 polyol were added to a 19 liter mixer. The mixer was run for about 30 sec, then about 26 g of PMDI was added to the mixture and mixed for about 2.5 min to produce coated proppants. Thereafter, the coated proppants were discharged from the mixer and allowed to cool in the ambient to about 23° C. The dry crush value was determined to be about 1.3 wt % at about 55.2 MPa.

### Example 9

About 2,000 g of sand was preheated to a temperature of about 260° C. and about 54 g of the Example 2 polyol were added to a 19 liter mixer. The mixer was run for about 30 sec, then about 26 g of PMDI was added to the mixture and mixed for about 2.5 min to produce coated proppants. Thereafter, the coated proppants were discharged from the mixer and allowed to cool in the ambient to about 23° C. The dry crush value was determined to be about 2 wt % at about 55.2 MPa.

### Example 10

About 2,000 g of sand was preheated to a temperature of about 260° C. and about 54 g of the Example 4 polyol were added to a 19 liter mixer. The mixer was run for about 30 sec, then about 26 g of PMDI was added to the mixture and mixed for about 2.5 min to produce coated proppants. Thereafter, the coated proppants were discharged from the mixer and allowed to cool in the ambient to about 23° C. The dry crush value was determined to be about 4.6 wt % at about 96.5 MPa.

The proppants (coated sand particles) were sieved using two sieves—a #20 (about 850 μm) sieve and a #40 mesh (about 0.4 mm) sieve. A sample of about 15 g of the sieved proppants was loaded into the test cell, constantly moving the test cell until a leveled surface of proppants was obtained. A press with a piston was used to apply stress to the sample in the test cell. The piston was inserted into the test cell and the press applied stress to the sample in the test cell. The stress was increased at a constant rate until the desired stress was achieved—either about 55.2 MPa (Examples 6-9) or about 96.5 MPa (Example 10). The sample was then held at the desired stress for about 2 min. The crushed coated proppant was then sieved and the amount of fines produced was reported. The results for Examples 6-10 are provided in Table 2.

TABLE 2
Dry Crush Strength of Coated Proppant

| | Polyol | Dry Crush | Crush Pressure |
|---|---|---|---|
| Ex | (Exp #) | (wt %) | MPa |
| 6 | 4 | 1.1 | 55.2 |
| 7 | 4 | 0.6 | 55.2 |
| 8 | 5 | 1.3 | 55.2 |
| 9 | 2 | 2 | 55.2 |
| 10 | 4 | 4.6 | 96.5 |

Embodiments of the present disclosure further relate to any one or more of the following paragraphs:

1. A coated proppant, comprising: a particle; and a polyurethane coating at least partially encasing the particle, wherein the polyurethane coating comprises a reaction product of a hyperbranched polyol and a polyisocyanate, wherein the hyperbranched polyol comprises a reaction product of a chain extender and a polyol monomer, and wherein the coated proppant has a dry crush strength of about 0.1 wt % to about 5 wt % at a pressure of about 96.5 MPa, based on the Proppant Crush Resistance Test Procedure under ISO 13503-2:2011.

2. A coated proppant, comprising: a particle; and a polyurethane coating at least partially encasing the particle, wherein the polyurethane coating comprises a reaction product of a hyperbranched polyol and a polyisocyanate, wherein the hyperbranched polyol consists essentially of carbon, hydrogen, and oxygen and has a degree of branching of about 35% to about 80%, wherein the coated proppant has a mesh size of about 80 (about 180 μm) and about 10 (about 2 mm), based on the U.S. Standard Sieve Series, and wherein the coated proppant has a dry crush strength of about 0.1 wt % to about 3 wt % at a pressure of about 55.2 MPa, based on the Proppant Crush Resistance Test Procedure under ISO 13503-2:2011.

3. The coated proppant according to paragraph 2, wherein the hyperbranched polyol comprises a reaction product of a chain extender and a polyol monomer.

4. The coated proppant according to any one of paragraphs 1 to 3, wherein the chain extender is dimethylolpropionic acid.

5. The coated proppant according to any one of paragraphs 1 to 4, wherein the polyol monomer is trimethylolpropane, trimethylolbutane, pentaerythritol, dipentaerythritol, glycerol, sorbitol, derivatives thereof, or any mixture thereof.

6. The coated proppant according to any one of paragraphs 1 to 5, wherein the chain extender is dimethylolpropionic acid and the polyol monomer is trimethylolpropane.

7. The coated proppant according to any one of paragraphs 1 to 6, wherein the coated proppant has a dry crush strength of about 0.5 wt % to less than 5 wt % at a pressure of about 96.5 MPa.

8. The coated proppant according to any one of paragraphs 1 to 7, wherein the polyurethane coating is completely encasing the particle, and wherein the coated proppant has a dry crush strength of about 0.1 wt % to about 3 wt % at a pressure of about 55.2 MPa, based on the Proppant Crush Resistance Test Procedure under ISO 13503-2:2011.

9. The coated proppant according to any one of paragraphs 1 to 8, wherein the coated proppant has a dry crush strength of about 0.5 wt % to less than 3 wt % at a pressure of about 55.2 MPa.

10. The coated proppant according to any one of paragraphs 1 to 9, wherein the hyperbranched polyol has a degree of branching of about 30% or greater.

11. The coated proppant according to any one of paragraphs 1 to 10, wherein the hyperbranched polyol has a degree of branching of about 35% to about 80%.

12. The coated proppant according to any one of paragraphs 1 to 11, wherein the hyperbranched polyol has a degree of branching of about 40% to about 60%.

13. The coated proppant according to any one of paragraphs 1 to 12, wherein the hyperbranched polyol has a number average molecular weight (Mₙ) of about 500 to about 3,000 and a weight average molecular weight (M_{w}) of about 800 to about 5,000, and wherein the number average molecular weight (Mₙ) is less than the weight average molecular weight (M_{w}).

14. The coated proppant according to any one of paragraphs 1 to 13, wherein the hyperbranched polyol has a number average molecular weight (Mₙ) of about 700 to about 2,000 and a weight average molecular weight (M_{w}) of about 900 to about 4,000.

15. The coated proppant according to any one of paragraphs 1 to 14, wherein the reaction product of the chain extender and the polyol monomer is produced by combining about 2 molar equivalents to about 30 molar equivalents of the chain extender to 1 molar equivalent of the polyol monomer.

16. The coated proppant according to paragraph 15, wherein the reaction product of the chain extender and the polyol monomer is produced by combining about 2 molar equivalents to about 5 molar equivalents of the chain extender to 1 molar equivalent of the polyol monomer.

17. The coated proppant according to paragraph 15, wherein the reaction product of the chain extender and the polyol monomer is produced by combining about 6 molar equivalents to about 12 molar equivalents of the chain extender to 1 molar equivalent of the polyol monomer.

18. The coated proppant according to paragraph 15, wherein the reaction product of the chain extender and the polyol monomer is produced by combining about 15 molar equivalents to about 25 molar equivalents of the chain extender to 1 molar equivalent of the polyol monomer.

19. The coated proppant according to any one of paragraphs 1 to 18, wherein the polyisocyanate comprises methylene diphenyl diisocyanate, toluene diisocyanate, isophorone diisocyanate, hexamethylene diisocyanate, methylenediphenylene diisocyanate, salts thereof, isomers thereof, derivatives thereof, or any mixture thereof.

20. The coated proppant according to any one of paragraphs 1 to 19, wherein the particle is sand, gravel, beads, pellets, nut or seed media, mineral fibers, natural fibers, synthetic fibers, or any mixture thereof.

21. The coated proppant according to any one of paragraphs 1 to 20, wherein the particle has a mesh size of about 40 (about 425 μm) to about 20 (about 850 μm), based on the U.S. Standard Sieve Series.

22. The coated proppant according to any one of paragraphs 1 to 21, wherein the particle has a mesh size of about 200 (about 75 μm) to about 20 (about 850 μm), based on the U.S. Standard Sieve Series.

23. The coated proppant according to any one of paragraphs 1 to 22, wherein the coated proppant has a mesh size of about 80 (about 180 μm) to about 10 (about 2 mm), based on the U.S. Standard Sieve Series.

24. The coated proppant according to any one of paragraphs 1 to 23, wherein the coated proppant has a mesh size of about 40 (about 425 μm) to about 20 (about 850 μm), based on the U.S. Standard Sieve Series.

25. The coated proppant according to any one of paragraphs 1 to 24, wherein the polyurethane coating has a thickness of about 2.5 μm to about 127 μm.

26. The coated proppant of any one of paragraphs 1 to 25, wherein the polyurethane coating is about 0.5 wt % to about 10 wt % of the coated proppant, based on the total weight of the coating and the particle.

27. A method for treating a subterranean formation, comprising: introducing a fluid comprising a plurality of coated proppants into a wellbore, wherein each coated proppant comprises: a particle; and a polyurethane coating at least partially encasing the particle, wherein the polyurethane coating comprises a reaction product of a hyperbranched polyol and a polyisocyanate, and wherein the hyperbranched polyol comprises a reaction product of a chain extender and a polyol monomer; and introducing the plurality of coated proppants into the subterranean formation via the wellbore.

28. A method for treating a subterranean formation, comprising: introducing a fluid comprising a plurality of coated proppants into a wellbore, wherein each coated proppant comprises: a particle; and a polyurethane coating at least partially encasing the particle, wherein the polyurethane coating comprises a reaction product of a hyperbranched polyol and a polyisocyanate, wherein the hyperbranched polyol comprises a reaction product of a chain extender and a polyol monomer, and wherein the coated proppant has a dry crush strength of about 0.1 wt % to about 5 wt % at a pressure of about 96.5 MPa, based on the Proppant Crush Resistance Test Procedure under ISO 13503-2:2011; and introducing the plurality of coated proppants into the subterranean formation via the wellbore.

29. A method for producing coated proppants, comprising: combining a chain extender and a polyol monomer to produce a hyperbranched polyol; combining the hyperbranched polyol, a polyisocyanate, and a plurality of particles to produce the coated proppants, wherein each coated proppant comprises a polyurethane coating at least partially encasing each of the particles, and wherein the polyurethane coating is a reaction product of the hyperbranched polyol and the polyisocyanate.

30. A method for producing coated proppants, comprising: combining a chain extender and a polyol monomer to produce a hyperbranched polyol; combining the hyperbranched polyol, a polyisocyanate, and a plurality of particles to produce the coated proppants, wherein each coated proppant comprises a polyurethane coating at least partially encasing each of the particles, wherein the polyurethane coating is a reaction product of the hyperbranched polyol and the polyisocyanate, and wherein the coated proppant has a dry crush strength of about 0.1 wt % to about 5 wt % at a pressure of about 96.5 MPa, based on the Proppant Crush Resistance Test Procedure under ISO 13503-2:2011.

31. The method according to any one of paragraphs 27 to 30, wherein the chain extender is dimethylolpropionic acid.

32. The method according to any one of paragraphs 27 to 31, wherein the polyol monomer is trimethylolpropane, trimethylolbutane, pentaerythritol, dipentaerythritol, glycerol, sorbitol, derivatives thereof, or any mixture thereof.

33. The method according to any one of paragraphs 27 to 32, wherein the chain extender is dimethylolpropionic acid and the polyol monomer is trimethylolpropane.

34. The method according to any one of paragraphs 27 to 33, wherein the coated proppant has a dry crush strength of about 0.5 wt % to less than 5 wt % at a pressure of about 96.5 MPa.

35. The method according to any one of paragraphs 27 to 34, wherein the polyurethane coating is completely encasing the particle, and wherein the coated proppant has a dry crush strength of about 0.1 wt % to about 5 wt % at a pressure of about 96.5 MPa, based on the Proppant Crush Resistance Test Procedure under ISO 13503-2:2011.

36. The method according to any one of paragraphs 27 to 35, wherein the polyurethane coating is completely encasing the particle, and wherein the coated proppant has a dry crush strength of about 0.1 wt % to about 3 wt % at a pressure of about 55.2 MPa, based on the Proppant Crush Resistance Test Procedure under ISO 13503-2:2011.

37. The method according to any one of paragraphs 27 to 36, wherein the coated proppant has a dry crush strength of about 0.5 wt % to less than 3 wt % at a pressure of about 55.2 MPa, based on the Proppant Crush Resistance Test Procedure under ISO 13503-2:2011.

38. The method according to any one of paragraphs 27 to 37, wherein the hyperbranched polyol has a number average molecular weight (Mₙ) of about 500 to about 3,000 and a weight average molecular weight (M_{w}) of about 800 to about 5,000, and wherein the number average molecular weight (Mₙ) is less than the weight average molecular weight (M_{w}).

39. The method according to any one of paragraphs 27 to 38, wherein the reaction product of the chain extender and the polyol monomer is produced by combining about 2 molar equivalents to about 30 molar equivalents of the dimethylolpropionic acid to 1 molar equivalent of the trimethylolpropane.

40. The method according to any one of paragraphs 27 to 39, wherein the hyperbranched polyol has a degree of branching of about 30% or greater.

41. The method according to any one of paragraphs 27 to 40, wherein the hyperbranched polyol has a degree of branching of about 35% to about 80%.

42. The method according to any one of paragraphs 27 to 41, wherein the hyperbranched polyol has a degree of branching of about 40% to about 60%.

43. The method according to any one of paragraphs 27 to 42, wherein the hyperbranched polyol has a number average molecular weight (Mₙ) of about 700 to about 2,000 and a weight average molecular weight (M_{w}) of about 900 to about 4,000.

44. The method according to any one of paragraphs 27 to 43, wherein the reaction product of the chain extender and the polyol monomer is produced by combining about 2 molar equivalents to about 30 molar equivalents of the chain extender to 1 molar equivalent of the polyol monomer.

45. The method according to any one of paragraphs 27 to 43, wherein the reaction product of the chain extender and the polyol monomer is produced by combining about 2 molar equivalents to about 5 molar equivalents of the chain extender to 1 molar equivalent of the polyol monomer.

46. The method according to any one of paragraphs 27 to 43, wherein the reaction product of the chain extender and the polyol monomer is produced by combining about 6 molar equivalents to about 12 molar equivalents of the chain extender to 1 molar equivalent of the polyol monomer.

47. The method according to any one of paragraphs 27 to 43, wherein the reaction product of the chain extender and the polyol monomer is produced by combining about 15 molar equivalents to about 25 molar equivalents of the chain extender to 1 molar equivalent of the polyol monomer.

48. The method according to any one of paragraphs 27 to 47, wherein the polyisocyanate comprises methylene diphenyl diisocyanate, toluene diisocyanate, isophorone diisocyanate, hexamethylene diisocyanate, methylenediphenylene diisocyanate, salts thereof, isomers thereof, derivatives thereof, or any mixture thereof.

49. The method according to any one of paragraphs 27 to 48, wherein the particle is sand, gravel, beads, pellets, nut or seed media, mineral fibers, natural fibers, synthetic fibers, or any mixture thereof.

50. The method according to any one of paragraphs 27 to 49, wherein the particle has a mesh size of about 40 (about 425 μm) to about 20 (about 850 μm), based on the U.S. Standard Sieve Series.

51. The method according to any one of paragraphs 27 to 50, wherein the particle has a mesh size of about 200 (about 75 μm) to about 20 (about 850 μm), based on the U.S. Standard Sieve Series.

52. The method according to any one of paragraphs 27 to 51, wherein the coated proppant has a mesh size of about 80 (about 180 μm) to about 10 (about 2 mm), based on the U.S. Standard Sieve Series.

53. The method according to any one of paragraphs 27 to 52, wherein the coated proppant has a mesh size of about 40 (about 425 μm) to about 20 (about 850 μm), based on the U.S. Standard Sieve Series.

54. The method according to any one of paragraphs 27 to 53, wherein the polyurethane coating has a thickness of about 2.5 μm to about 127 μm.

55. The method according to any one of paragraphs 27 to 54, wherein the polyurethane coating is about 0.5 wt % to about 10 wt % of the coated proppant, based on the total weight of the coating and the particle.

56. The method according to any one of paragraphs 27 to 55, further comprising servicing the subterranean formation with the plurality of coated proppants.

57. The coated proppant or method according to any one of paragraphs 1 to 56, wherein a plurality of the coated proppants has a dry crush strength of about 0.5 wt % to less than 5 wt % at a pressure of about 96.5 MPa.

58. The coated proppant or method according to any one of paragraphs 1 to 57, wherein a plurality of the coated proppants has a dry crush strength of about 0.1 wt % to about 3 wt % at a pressure of about 55.2 MPa, based on the Proppant Crush Resistance Test Procedure under ISO 13503-2:2011.

59. The coated proppant or method according to any one of paragraphs 1 to 58, wherein a plurality of the coated proppants has a dry crush strength of about 0.5 wt % to less than 3 wt % at a pressure of about 55.2 MPa, based on the Proppant Crush Resistance Test Procedure under ISO 13503-2:2011.

60. The coated proppant or method according to any one of paragraphs 1 to 7, 9 to 34, or 37 to 59, wherein the polyurethane coating completely encases the particle.

61. The coated proppant or method according to any one of paragraphs 1 to 7, 9 to 34, or 37 to 59, wherein the polyurethane coating partially encases the particle.

62. The coated proppant or method according to any one of paragraphs 1 to 61, wherein the particle is sand.

63. The coated proppant or method according to any one of paragraphs 1 to 62, wherein the hyperbranched polyol consists essentially of carbon, hydrogen, and oxygen.

64. The coated proppant or method according to any one of paragraphs 1 to 62, wherein the hyperbranched polyol consists of carbon, hydrogen, and oxygen.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A coated proppant, comprising:
a particle; and
a polyurethane coating at least partially encasing the particle, wherein the polyurethane coating comprises a reaction product of a hyperbranched polyol and a polyisocyanate, wherein the hyperbranched polyol comprises a reaction product of a chain extender and a polyol monomer, and wherein the coated proppant has a dry crush strength of about 0.1 wt % to about 5 wt % at a pressure of about 96.5 MPa, based on the Proppant Crush Resistance Test Procedure under ISO 13503-2:2011.

2. The coated proppant of claim 1, wherein the polyol monomer comprises trimethylolpropane, trimethylolbutane, pentaerythritol, dipentaerythritol, glycerol, sorbitol, salts thereof, isomers thereof, or any mixture thereof.

3. The coated proppant of claim 1, wherein the chain extender comprises dimethylolpropionic acid and the polyol monomer comprises trimethylolpropane.

4. The coated proppant of claim 1, wherein the polyurethane coating completely encases the particle, and wherein the coated proppant has a dry crush strength of about 0.1 wt % to about 3 wt % at a pressure of about 55.2 MPa, based on the Proppant Crush Resistance Test Procedure under ISO 13503-2:2011.

5. The coated proppant of claim 1, wherein the hyperbranched polyol has a degree of branching of about 30% to about 90%, and wherein the hyperbranched polyol consists essentially of carbon, hydrogen, and oxygen.

6. The coated proppant of claim 1, wherein the hyperbranched polyol has a number average molecular weight (Mₙ) of about 500 to about 3,000 and a weight average molecular weight (M_{w}) of about 800 to about 5,000, and wherein the number average molecular weight (Mₙ) is less than the weight average molecular weight (M_{w}).

7. The coated proppant of claim 1, wherein the reaction product of the chain extender and the polyol monomer is produced by combining about 2 molar equivalents to about 30 molar equivalents of the chain extender to 1 molar equivalent of the polyol monomer.

8. The coated proppant of claim 1, wherein the reaction product of the chain extender and the polyol monomer is produced by combining about 2 molar equivalents to about 5 molar equivalents of the chain extender to 1 molar equivalent of the polyol monomer.

9. The coated proppant of claim 1, wherein the reaction product of the chain extender and the polyol monomer is produced by combining about 6 molar equivalents to about 12 molar equivalents of the chain extender to 1 molar equivalent of the polyol monomer.

10. The coated proppant of claim 1, wherein the reaction product of the chain extender and the polyol monomer is produced by combining about 15 molar equivalents to about 25 molar equivalents of the chain extender to 1 molar equivalent of the polyol monomer.

11. The coated proppant of claim 1, wherein the polyisocyanate comprises methylene diphenyl diisocyanate, toluene diisocyanate, isophorone diisocyanate, hexamethylene diisocyanate, methylenediphenylene diisocyanate, salts thereof, isomers thereof, or any mixture thereof.

12. The coated proppant of claim 1, wherein the particle is sand, gravel, nut media, seed media, a mineral fiber, a natural fiber, or a synthetic fiber.

13. The coated proppant of claim 1, wherein the coated proppant has a mesh size of about 80 to about 10, based on the U.S. Standard Sieve Series.

14. The coated proppant of claim 1, wherein:
the particle is sand,
the reaction product of the chain extender and the polyol monomer is produced by combining about 2 molar equivalents to about 30 molar equivalents of the chain extender to 1 molar equivalent of the polyol monomer,
the polyol monomer comprises trimethylolpropane, trimethylolbutane, pentaerythritol, dipentaerythritol, glycerol, sorbitol, salts thereof, isomers thereof, or any mixture thereof,
the chain extender comprises dimethylolpropionic acid, diethylolpropionic acid, dipropylolpropionic acid, salts thereof, isomers thereof, or any mixture thereof,
the polyisocyanate comprises methylene diphenyl diisocyanate, toluene diisocyanate, isophorone diisocyanate, hexamethylene diisocyanate, methylenediphenylene diisocyanate, salts thereof, isomers thereof, or any mixture thereof, and
the coated proppant has a dry crush strength of about 0.1 wt % to about 3 wt % at a pressure of about 55.2 MPa, based on the Proppant Crush Resistance Test Procedure under ISO 13503-2:2011.

15. A coated proppant, comprising:
a particle; and
a polyurethane coating at least partially encasing the particle, wherein the polyurethane coating comprises a reaction product of a hyperbranched polyol and a polyisocyanate, wherein the hyperbranched polyol consists essentially of carbon, hydrogen, and oxygen and has a degree of branching of about 35% to about 80%, wherein the coated proppant has a mesh size of about 80 to about 10, based on the U.S. Standard Sieve Series, and wherein the coated proppant has a dry crush strength of about 0.1 wt % to about 3 wt % at a pressure of about 55.2 MPa, based on the Proppant Crush Resistance Test Procedure under ISO 13503-2:2011.

16. The coated proppant of claim 15, wherein:
the particle is sand,
the hyperbranched polyol comprises a reaction product of dimethylolpropionic acid and trimethylolpropane,
the reaction product of dimethylolpropionic acid and trimethylolpropane is produced by combining about 2 molar equivalents to about 30 molar equivalents of dimethylolpropionic acid to 1 molar equivalent of trimethylolpropane,
the polyisocyanate comprises methylene diphenyl diisocyanate, and
the coated proppant has a dry crush strength of about 0.1 wt % to about 5 wt % at a pressure of about 96.5 MPa, based on the Proppant Crush Resistance Test Procedure under ISO 13503-2:2011.

17. A method for treating a subterranean formation, comprising:
introducing a fluid comprising a plurality of coated proppants into a wellbore, wherein each coated proppant comprises:
a particle; and
a polyurethane coating at least partially encasing the particle, wherein the polyurethane coating comprises a reaction product of a hyperbranched polyol and a polyisocyanate, and wherein the hyperbranched polyol comprises a reaction product of a chain extender and a polyol monomer; and
introducing the plurality of coated proppants into the subterranean formation via the wellbore.

18. The method of claim 17, wherein the polyol monomer comprises trimethylolpropane, trimethylolbutane, pentaerythritol, dipentaerythritol, glycerol, sorbitol, salts thereof, isomers thereof, or any mixture thereof, and wherein the chain extender comprises dimethylolpropionic acid, diethylolpropionic acid, dipropylolpropionic acid, salts thereof, isomers thereof, or any mixture thereof.

19. The method of claim 17, wherein the polyurethane coating completely encases the particle, and wherein the coated proppant has a dry crush strength of about 0.1 wt % to about 5 wt % at a pressure of about 96.5 MPa, based on the Proppant Crush Resistance Test Procedure under ISO 13503-2:2011.

20. The method of claim 17, wherein the hyperbranched polyol has a number average molecular weight (Mₙ) of about 500 to about 3,000 and a weight average molecular weight (M_{w}) of about 800 to about 5,000, wherein the number average molecular weight (Mₙ) is less than the weight average molecular weight (M_{w}), and wherein the reaction product of the chain extender and the polyol monomer is produced by combining about 2 molar equivalents to about 30 molar equivalents of the chain extender to 1 molar equivalent of the polyol monomer.
